(19) United States
(12) Patent Application Publication
(10) Pub. No.: US 2007/0192793 A1
(43) Pub. Date: Aug. 16, 2007

(54) Electronic programming guide providing apparatus and method

(75) Inventors: Tae-young Song, Seoul (KR); Young-chul Sohn, Seoul (KR); Yong-jun Kim, Yongin-si (KR); Hyo-dae Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/580,980

(22) Filed: Oct. 16, 2006

(30) Foreign Application Priority Data
Feb. 11, 2006 (KR) 10-2006-0013336
Feb. 11, 2006 (KR) 10-2006-0013337

(51) Int. Cl. H04N 7/173; G06F 3/00; G06F 13/00; H04N 7/16; H04N 5/445

(52) U.S. Cl. 725/39; 725/134; 725/142

(57) ABSTRACT

An electronic programming guide (EPG) providing apparatus and method to collectively manage broadcast content using stored EPG information are provided. The EPG providing apparatus includes a storing unit which stores broadcast content and EPG information, an EPG screen configuring unit which configures an EPG screen including information on past, current, and future broadcast content using the EPG information, and a control unit which collectively manages broadcast content provided on the EPG screen based on a user input signal.

### CROSS-REFERENCE TO RELATED PATENT APPLICATION

This application claims priority from Korean Patent Application Nos. 10-2006-0013336 and 10-2006-0013337, filed on Feb. 11, 2006, in the Korean Intellectual Property Office, the disclosures of which are incorporated herein in their entirety by reference.

### BACKGROUND OF THE INVENTION

1. Field of the Invention

Apparatuses and methods consistent with the present invention relates to collectively managing broadcast content using stored electronic programming guide (EPG) information, and more particularly, to allowing a user of a digital recorder to easily manage previously recorded, currently broadcasted, or to-be-broadcasted content using EPG information.

Apparatuses and methods consistent with the present invention also relate to providing a video-on-demand (VOD) service using EPG information, and more particularly, storing and providing EPG information for a past broadcast content and providing non-recorded broadcast content using a VOD service.

2. Description of the Related Art

An electronic programming guide (EPG) has become an increasing matter of concern in an environment where a broadcasting service is provided over multiple channels by various media such as terrestrial waves, satellites, and cables. In a related EPG apparatus, users are generally provided with EPG information by manipulating a multimedia recording device such as a personal video recorder (PVR) that provides an EPG using a remote control. The users select broadcast content included in the provided EPG to view or record currently provided or to-be-provided broadcast content.

However, the EPG information only includes currently broadcasted or to-be-broadcasted information. As a result, to check previously broadcasted broadcast content information, the users must take a different path. In addition, the users can view previously broadcasted broadcast content that is not recorded only after doing a search for the broadcast content using the checked broadcast content information.

For example, to check previously broadcasted broadcast content information, the users should connect to a broadcasting service provider or a web site that provides past broadcast content information using a computer connected to a network. Moreover, the users may not be able to use a multimedia recorder that has been employed to use past broadcast content, and so may have to connect to a broadcasting service provider or a web site that provides the past broadcast content through a computer connected to a network, purchase and download the past broadcast content.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention is to provide an electronic programming guide (EPG) providing apparatus and method, by which not only EPG information for currently broadcasted and to-be-broadcasted broadcast content (current and future broadcast content) but also EPG information for previously broadcasted broadcast content (past broadcast content) is stored and provided to a user so that the user can collectively manage the broadcast content.

An aspect of the present invention is to also provide an EPG providing apparatus for and method of providing a video-on-demand (VOD) service using EPG information, in which EPG information for past broadcast content is stored and provided and non-recorded broadcast content is provided through the VOD service.

According to an aspect of the present invention, there is provided an EPG providing apparatus including a storing unit, an EPG screen configuring unit, and a control unit. The storing unit stores broadcast content and EPG information. The EPG screen configuring unit configures an EPG screen including information on past, current, and future broadcast content using the EPG information such that the broadcast content stored in the storing unit can be distinguished from broadcast content that is not stored in the storing unit. The control unit collectively manages broadcast content provided on the EPG screen based on a user input signal for the broadcast content.

The EPG providing apparatus may further include a broadcasting signal processing unit which processes a received broadcasting signal and generates the broadcast content and the EPG information and a decoder which decodes the broadcast content that is read from the storing unit or generated by the broadcasting signal processing unit.

The EPG screen configuring unit may omit regions for providing information on broadcast content that is not included in the broadcasting time frames of the stored broadcast content or reduce the sizes of the regions when it configures the EPG screen to provide information on the past broadcast content.

The control unit may control the EPG screen configuring unit to display information on broadcast content included in the reduced region selected by a selection signal upon receipt of the selection signal with respect to the reduced region.

The EPG screen configuring unit may reduce the sizes of regions for providing information on broadcast content, which is not included in the broadcasting time frames of the stored broadcast content or is broadcasted through different channels than the stored broadcast content, when it configures the EPG screen to provide information on the past broadcast content.

The control unit may control the decoder to decode and reproduce broadcast content selected by a selection signal with respect to the past broadcast content stored in the storing unit or manage the broadcast content stored in the storing unit by deleting or changing the stored broadcast content.

The EPG screen configuring unit may configure the EPG screen such that the EPG screen includes information indicating that the current broadcast content is being recorded, and the control unit may control the decoder to decode and reproduce current broadcast content selected by a selection signal with respect to the current broadcast content.

The EPG screen configuring unit may configure the EPG screen such that the EPG screen includes information indicating whether the future broadcast content is subject to reserved recording, and the control unit may set or cancel the reserved recording of future broadcast content selected by a selection signal with respect to the future broadcast content.

According to another aspect of the present invention, there is provided an EPG providing method including storing broadcast content and EPG information, configuring an EPG screen including information on past, current, and future broadcast content using the EPG information such that the stored broadcast content can be distinguished from broadcast content that is not stored, and collectively managing broadcast content provided on the EPG screen based on a user input signal for the broadcast content.

According to still another aspect of the present invention, there is provided an EPG providing apparatus for providing a VOD service using EPG information. The EPG providing apparatus includes a storing unit, a control unit, and a communicating unit. The storing unit stores broadcast content and EPG information. The control unit receives a user input signal for selecting broadcast content, reads EPG information for the selected broadcast content from the storing unit, and generates a uniform resource locator (URL) using the read EPG information. The communicating unit is provided with a VOD service for the selected broadcast content from a VOD server that provides VOD services using the generated URL.

The control unit may include a URL generating unit which generates the URL using a previously stored address and port number of the VOD server and broadcasting channel number information and broadcasting start time information of the selected broadcast content included in the EPG information.

The URL generating unit may generate the URL by additionally using a user ID and a user password required for member authentication if the VOD server requires the member authentication.

The EPG providing apparatus may further include a signal processing unit which processes a received broadcasting signal and generates the broadcast content and the EPG information and a decoder which decodes and outputs the broadcast content. The control unit may store the generated broadcast content and EPG information in the storing unit and control the decoder to decode and provide the broadcast content.

The communication unit may be provided with the VOD service for the selected broadcast content from the VOD server in a streaming manner.

The EPG providing apparatus may further include an EPG screen configuring unit which processes the stored EPG information into a format that can be displayed on a screen. The EPG screen configuring unit may configure an EPG screen to display EPG information for past, current, and future broadcast content.

The EPG screen configuring unit may configure the EPG screen such that the EPG screen includes information indicating whether the past broadcast content has been recorded and stored in the storing unit.

The EPG screen configuring unit may configure the EPG screen such that the EPG screen includes information indicating that the past broadcast content can be provided through the VOD service.

The screen configuring unit may configure the EPG screen such that the EPG screen includes information indicating whether the future broadcast content is subject to reserved recording.

The control unit may determine whether the broadcast content selected by the user input signal is stored in the storing unit, generate a URL using the read EPG information to provide the VOD service for the selected broadcast content if the selected broadcast content is not stored in the storing unit, and read and reproduce the selected broadcast content if the selected broadcast content is stored in the storing unit.

According to yet another aspect of the present invention, there is provided an EPG providing method to provide a VOD service using EPG information. The EPG providing method includes receiving a user input signal for selecting broadcast content, generating a URL using EPG information for the selected broadcast content, and being provided with a VOD service for the selected broadcast content from a VOD server that provides VOD services using the generated URL.

### BRIEF DESCRIPTION OF THE DRAWINGS

The above and other aspects of the present invention will become more apparent by describing in detail exemplary embodiments thereof with reference to the attached drawings in which:

FIG. 1 schematically illustrates a system including an electronic programming guide (EPG) providing apparatus to collectively manage broadcast content according to an exemplary embodiment of the present invention;

FIG. 2 is a block diagram of an EPG providing apparatus to collectively manage broadcast content according to an exemplary embodiment of the present invention;

FIG. 3 illustrates an EPG screen provided by an EPG providing apparatus according to an exemplary embodiment of the present invention;

FIG. 4 illustrates an EPG screen provided by an EPG providing apparatus according to another exemplary embodiment of the present invention;

FIG. 5 illustrates an EPG screen provided by an EPG providing apparatus according to another exemplary embodiment of the present invention;

FIG. 6 illustrates an EPG screen provided by an EPG providing apparatus according to another exemplary embodiment of the present invention;

FIG. 7 is a view for comparing EPG screens of FIGS. 4 and 6, provided by an EPG providing apparatus to collectively manage broadcast content;

FIG. 8 is a flowchart illustrating an EPG providing method according to an exemplary embodiment of the present invention;

FIG. 9 illustrates a system for providing a video-on-demand (VOD) service using EPG information according to an exemplary embodiment of the present invention;

FIG. 10 is a block diagram of an EPG providing apparatus for providing a VOD service using EPG information according to an exemplary embodiment of the present invention;

FIG. 11 illustrates a table showing elements of a uniform resource locator (URL) used to be provided with a VOD service according to an exemplary embodiment of the present invention;

FIG. 12 is a flowchart illustrating a VOD service providing method according to an exemplary embodiment of the present invention;

FIG. 13 is a flowchart illustrating a VOD service providing method according to another exemplary embodiment of the present invention; and

FIG. 14 illustrates a screen for providing a VOD service using EPG information according to an exemplary embodiment of the present invention.

### DETAILED DESCRIPTION OF THE EXEMPLARY EMBODIMENTS OF THE INVENTION

Hereinafter, exemplary embodiments of the present invention will be described in detail with reference to the accompanying drawings.

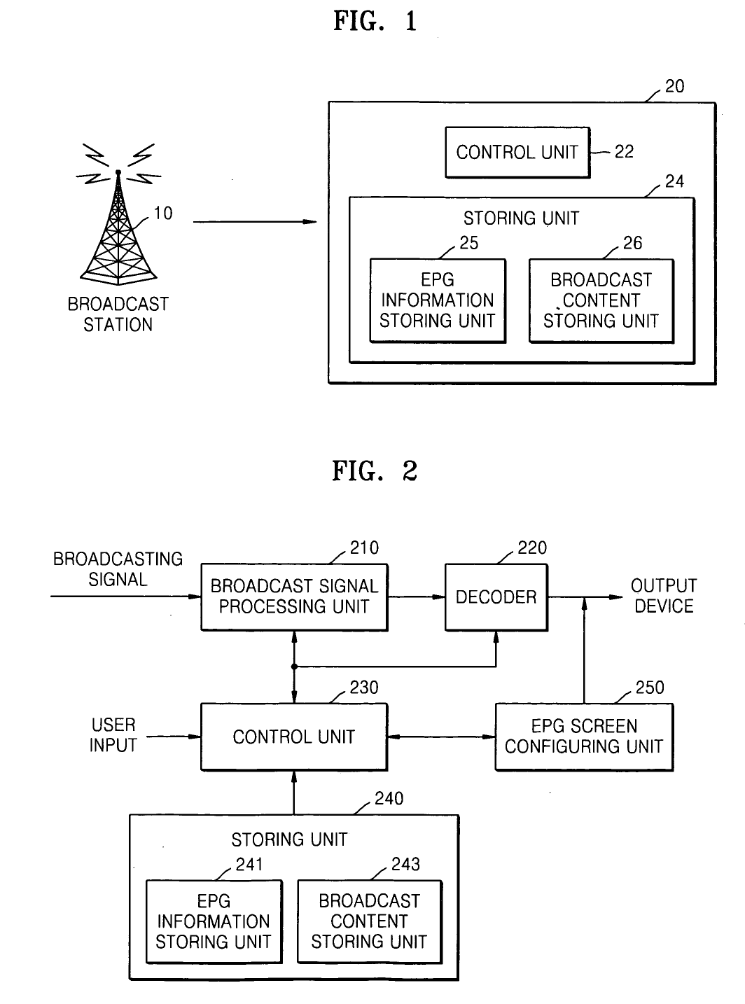

FIG. 1 schematically illustrates a system including an electronic programming guide (EPG) providing apparatus to collectively manage broadcast content according to an exemplary embodiment of the present invention.

A broadcasting station 10 provides EPG information and broadcast content to an EPG providing apparatus 20 through a broadcasting signal. The EPG information may include titles, broadcasting channels, broadcasting time of broadcast content, categories of broadcasting programs, the number of broadcasting times, starring actors, and brief information of the broadcast content and so on. Although the EPG providing apparatus 20 illustrated in FIG. 1 is provided with the EPG information from the broadcasting station 10, it may also be provided with the EPG information from an operator or a device that provides an EPG service.

The EPG providing apparatus 20 according to an exemplary embodiment of the present invention may be implemented with a personal video recorder (PVR), a personal computer (PC), or other devices capable of receiving and recording broadcast content. The EPG providing apparatus 20 can receive and store EPG information of all broadcasting channels at a specific time set by a user or at the issuance of an EPG information update command. The EPG providing apparatus 20 processes a broadcasting signal and stores the EPG information and broadcast content included in the broadcasting signal in a storing unit 24. A content management application is installed in a control unit 22 to manage the EPG information stored in the storing unit 24 based on a user input signal. The storing unit 24 may include an EPG information storing unit 25 for storing the EPG information and a broadcast content storing unit 26 for storing the broadcast content.

FIG. 2 is a block diagram of an EPG providing apparatus to collectively manage broadcast content according to an exemplary embodiment of the present invention. The EPG providing apparatus includes a broadcasting signal processing unit 210, a decoder 220, a control unit 230, a storing unit 240, and an EPG screen configuring unit 250.

The broadcasting signal processing unit 210 processes a received broadcasting signal to generate broadcast content and EPG information. The broadcasting signal processing unit 210 may include a tuner (not shown) that tunes and demodulates a broadcasting signal input through a specific channel selected by a user and outputs a transport stream and a demultiplexer (not shown) that demultiplexes a multiplexed transport stream output from the tuner into EPG information and broadcast content including a video stream and an audio stream. The decoder 220 receives the video/audio transport streams from the demultiplexer and decodes them to output video/audio signals. The configuration of the broadcasting signal processing unit 210 may vary with the type of a broadcasting signal to be processed.

The control unit 230 stores the broadcast content and the EPG information generated by the broadcasting signal processing unit 210 in the storing unit 240. The storing unit 240 may store the broadcast content and the EPG information in different spaces, e.g., an EPG information storing unit 241 and a broadcast content storing unit 243 as illustrated in FIG. 2.

Upon receipt of a user input signal requesting an EPG from a user input device such as a remote control device, the control unit 230 reads the EPG information stored in the storing unit 240 and controls the EPG screen configuring unit 250 to configure an EPG screen to provide an EPG to the user using the read EPG information.

The EPG screen configuring unit 250 may configure and provide an EPG screen including information on previously broadcasted broadcast content (past broadcast content), currently broadcasted broadcast content (current broadcast content), and to-be-broadcasted broadcast content (future broadcast content) under the control of the controller 230. In a related EPG providing apparatus, EPG information that is previously provided by an EPG provider such as a broadcasting station is deleted without being stored. However, the EPG providing apparatus according to an exemplary embodiment of the present invention stores previously provided EPG information in the storing unit 240. Thus, when the user requests an EPG, the EPG providing apparatus can provide an EPG including information not only on current and future broadcast content but also on past broadcast content.

The EPG screen configuring unit 250 configures the EPG screen such that information on broadcast content that is recorded and stored in the storing unit 240 can be distinguished from information on broadcast content that is not stored in the storing unit 240. For example, regions of the EPG screen designed to provide the information on the recorded broadcast content may be expressed with a different color than regions of the EPG screen for providing the information on the non-recorded broadcast content. The recorded broadcast content may also be indicated by a moving picture thumb nail or icon, so as to be distinguished from the non-recorded broadcast content. Thus, the user can easily check information on broadcast content that has been recorded and the recorded programs can be immediately played, using the EPG screen that provides information on the past broadcast content.

When the EPG screen configuring unit 250 configures the EPG screen designed to provide the information on the past broadcast content, it may omit regions designed to provide information on broadcast content that is not included in the broadcasting time frames of stored broadcast content or reduce the sizes of the regions, so as to allow the user to easily recognize the information on the recorded and stored broadcast content. At this time, if a selection signal corresponding to the reduced region is input from the user input device, the control unit 230 may control the EPG screen configuring unit 250 to display information on broadcast content included in the reduced region selected by the selection signal.

When the EPG screen configuring unit 250 configures the EPG screen designed to provide information on past broadcast content, it may also reduce the size of a region designed to provide information on broadcast content that is not included in the broadcasting time frame and broadcasting channel of stored broadcast content. At this time, if a selection signal corresponding to the reduced region is input from the user input device, the control unit 230 may control the EPG screen configuring unit 250 to display information on broadcast content included in the reduced region selected by the selection signal.

When the EPG screen configuring unit 250 displays information on current broadcast content, it may configure the EPG screen such that the EPG screen includes information indicating that the current broadcast content is being recorded. When the EPG screen configuring unit 250 displays information on future broadcast content, it may configure the EPG screen such that the EPG screen includes information indicating whether the future broadcast content is subject to reserved recording using reserved recording setting information that is set by the user input signal and provided from the control unit 230.

The control unit 230 receives the user input signal with respect to broadcast content provided in the EPG screen and collectively manages the broadcast content based on the received user input signal. The control unit 230 may also separately manage past, current or future broadcast content as described below. Upon receipt of a selection signal with respect to broadcast content included in the information on the past broadcast content stored in the storing unit 240 from the user input device, the control unit 230 may control the decoder 220 to decode and reproduce the broadcast content selected by the selection signal. The control unit 230 may also manage broadcast content in order to delete or change the broadcast content included in the information on the past broadcast content stored in the storing unit 240 based on the user input signal. Upon receipt of a selection signal with respect to broadcast content included in the information on the current broadcast content from the user input device, the control unit 230 may control the decoder 220 to decode and reproduce the selected broadcast content. Upon receipt of a selection signal with respect to broadcast content included in the information on the future broadcast content from the user input device, the control unit 230 may set or cancel the reserved recording of the selected broadcast content.

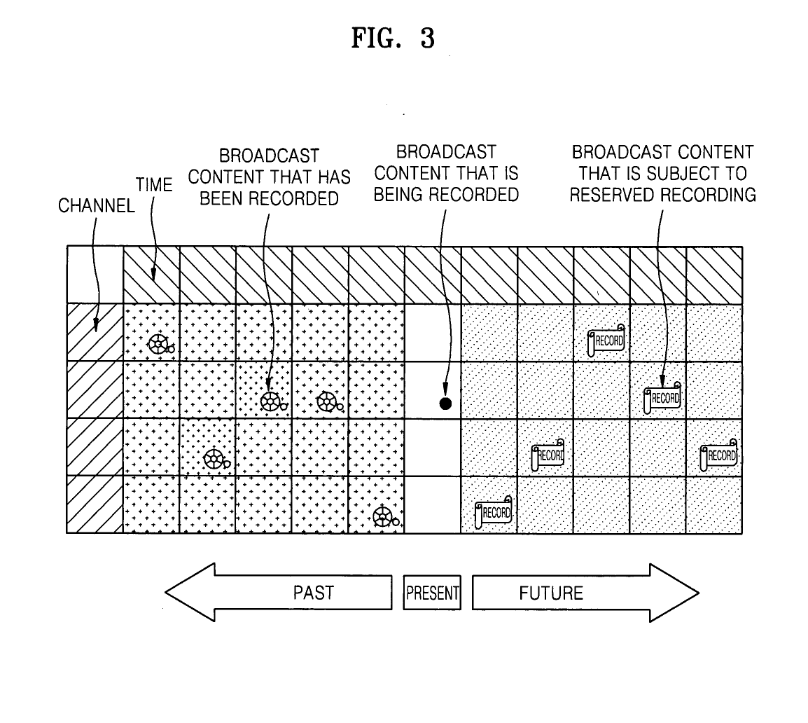

FIG. 3 illustrates an EPG screen provided by an EPG providing apparatus according to an exemplary embodiment of the present invention.

As illustrated in FIG. 3, an EPG screen for collectively managing broadcast content according to an exemplary embodiment of the present invention has a channel axis and a time axis and can provide an EPG for past, current, and future broadcast content. When an EPG for past broadcast content is provided, it may include information indicating whether the past broadcast content has been recorded. When an EPG for current broadcast content is provided, it may include information indicating the current broadcast content is being recorded. When an EPG for future broadcast content is provided, it may include information indicating whether the future broadcast content is subject to reserved recording.

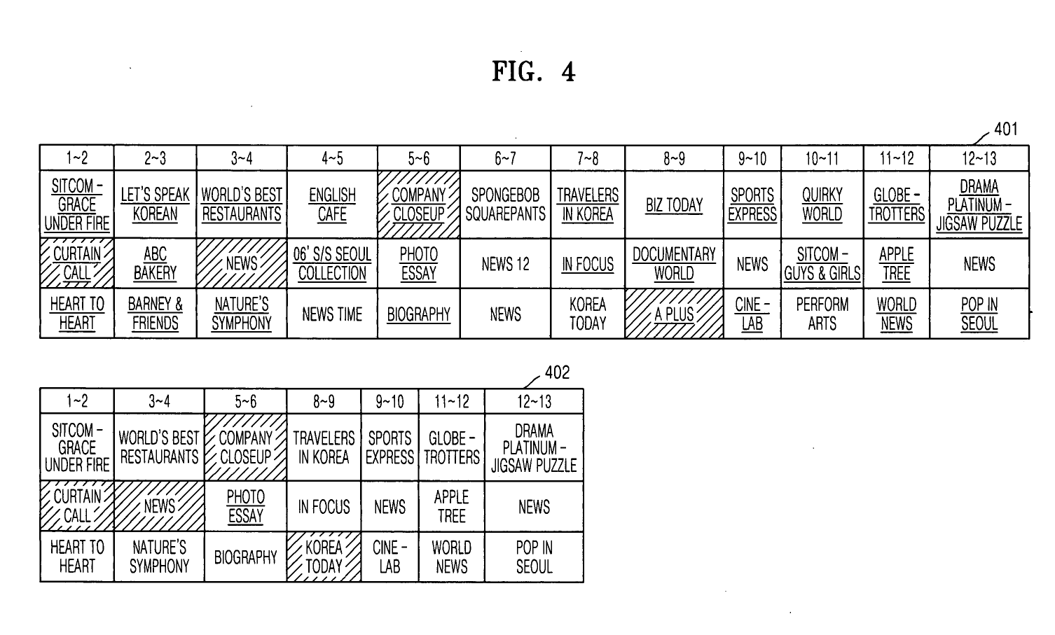

Hereinafter, an EPG screen, according to an exemplary embodiment of the present invention, used to effectively provide EPG information for the past broadcast content will be described with reference to FIGS. 4 through 7. FIG. 4 illustrates an EPG screen provided by an EPG providing apparatus according to another exemplary embodiment of the present invention.

In FIG. 4, an EPG screen 401 shows EPG information for current, past, and future broadcast content corresponding to each time frame. If the current time is included in a time frame 9-10, the EPG providing apparatus expresses past broadcast content that has been recorded with dashed lines to distinguish the broadcast content from non-recorded broadcast content, as illustrated in the screen 401. In an EPG screen 402, regions for providing an EPG for current and future broadcast content are the same as those of the EPG screen 401 and regions for providing an EPG for past broadcast content provide only information on broadcast content included in the recording time frames of the past broadcast content. By omitting information on broadcast content included in time frames in which the past broadcast content is not recorded, the user can more easily recognize recorded broadcast content in the EPG screen 402 than in the EPG screen 401 and easily select and play recorded broadcast content.

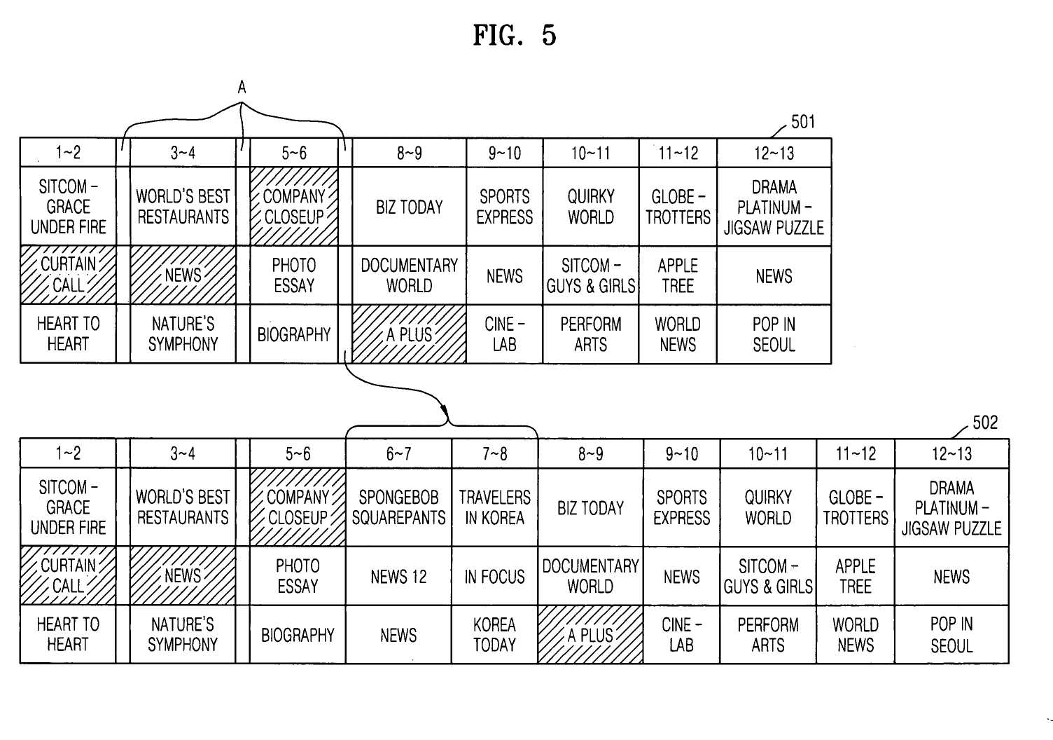

FIG. 5 illustrates an EPG screen provided by an EPG providing apparatus according to another exemplary embodiment of the present invention. In FIG. 5, an EPG screen 501 shows EPG information for current, past, and future broadcast content corresponding to each time frame. In FIG. 5, it is assumed that the current time is included in a time frame 9-10 like in FIG. 4. To provide an EPG for past broadcast content in the EPG screen 501, information on broadcast content that is not included in the broadcasting time frames of recorded broadcast content is displayed as reduced regions A.

Once the user inputs a selection signal with respect to the reduced region A using the user input device such as a remote control device, EPG information for broadcast content included in the selected reduced region A is displayed as in an EPG screen 502. Thus, the user can check information on past broadcast content included in the broadcasting time frames of recorded broadcast content using the provided screen 501 and can also be provided with information on broadcast content included in the broadcasting time frames of non-recorded broadcast content as shown in the EPG screen 502.

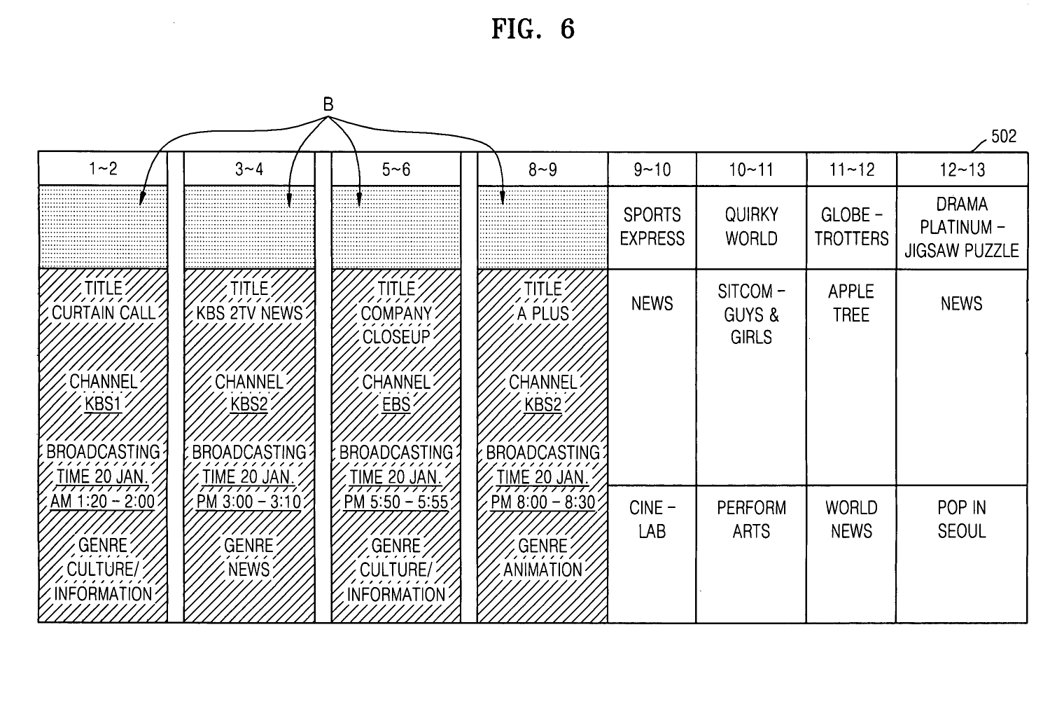

FIG. 6 illustrates an EPG screen provided by an EPG providing apparatus according to another exemplary embodiment of the present invention. The EPG screen illustrated in FIG. 6 is another form of the EPG screen 502 of FIG. 5. In FIG. 6, it is assumed that the current time is included in a time frame 9-10 like in FIG. 5.

In the EPG screen of FIG. 6, broadcast content included in the broadcasting time frames of past broadcast content that has been stored is concealed because it is broadcasted through different channels than the stored past broadcast content. For example, information on “Sitcom—Grace Under Fire” and “Heart to Heart” that has not been recorded in a time frame 1-2 in the EPG screen 502 of FIG. 5 is displayed as a reduced region B. Detailed information of “Curtain Call” that has been recorded in a time frame 1-2, i.e., its title, channel, broadcasting time, and genre, is further displayed in a region that is enlarged due to the reduction of the region for the information about the non-recorded broadcast content. As described with reference to FIG. 5, when the user desires to view information on broadcast content included in the reduced region B, the user can check information on broadcast content that has been broadcasted in the same broadcasting time frame, but through different channels than recorded broadcast content by inputting a selection signal with respect to the reduced region B.

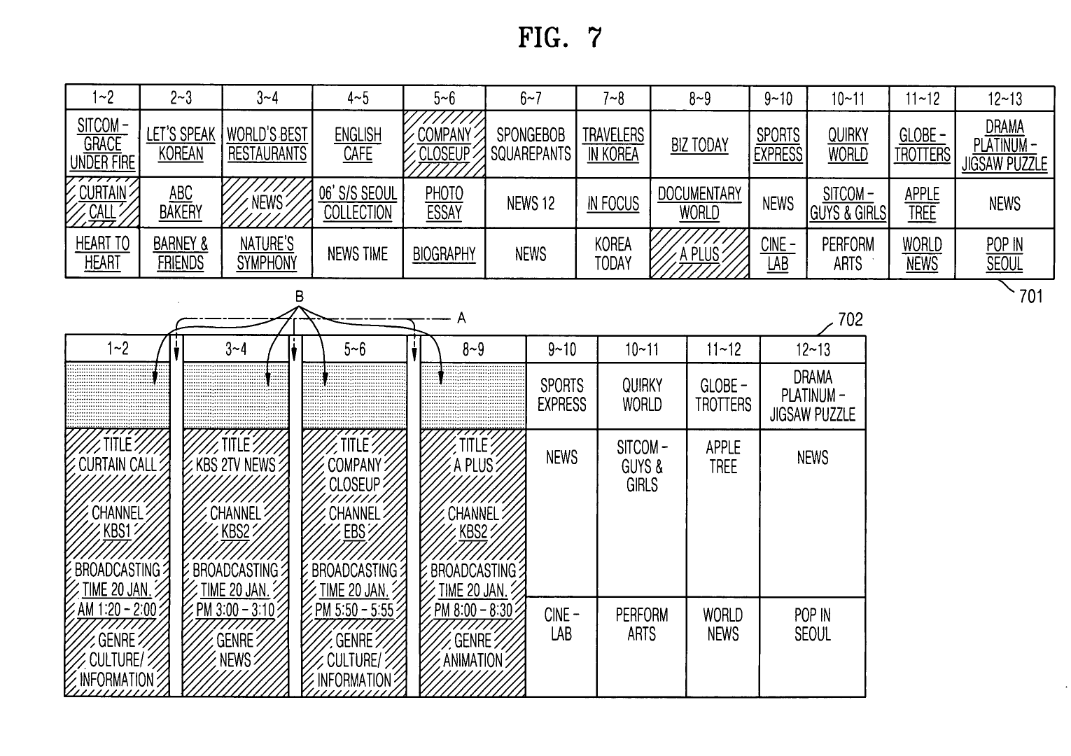

FIG. 7 is a view for comparing EPG screens of FIGS. 4 and 6, provided by an EPG providing apparatus to collectively manage broadcast content. Like the EPG screen 401 of FIG. 4, an EPG screen 701 shows EPG information for current, past, and future broadcast content corresponding to each time frame. In the EPG screen 701, past broadcast content that has been recorded is expressed with dashed lines to be distinguished from non-recorded broadcast content. In an EPG screen 702, as in the EPG screen of FIG. 6, information on broadcast content that is not included in the broadcasting time frames of recorded broadcast content is displayed as reduced regions A and information on broadcast content that is included in the broadcasting time frames of the recorded broadcast content but is broadcasted through different channels than the recorded broadcast content is displayed as reduced regions B.

The EPG screen 701 or 702 may be provided to the user as desired. In other words, the user may be provided with the EPG screen 701 by manipulating the user input device when desiring to collectively check information on past broadcast content, and the user may be provided with the EPG screen 702 when desiring to be provided with detailed information on recorded broadcast content. An EPG providing apparatus for collectively managing broadcast content may be configured to selectively provide various EPG screens of FIGS. 4 through 7 according to a user's requirements.

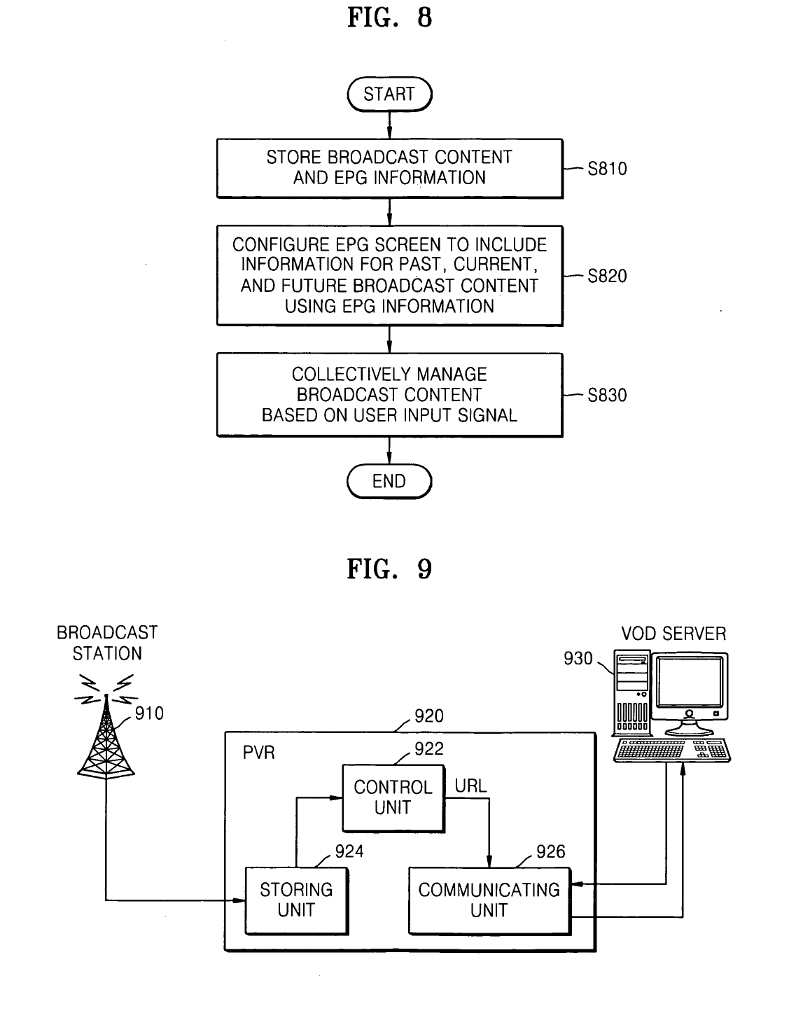

FIG. 8 is a flowchart illustrating an EPG providing method according to an exemplary embodiment of the present invention.

The control unit 230 stores broadcast content and EPG information generated in the broadcasting signal processing unit 210 in the storing unit 240 in operation S810. The EPG screen configuring unit 250 configures an EPG screen including information on past, current, and future broadcast content using the EPG information stored in the storing unit 240 under the control of the control unit 230 in operation S820. At this time, the EPG screen configuring unit 250 configures the EPG screen such that broadcast content stored in the storing unit 240 can be distinguished from broadcast content that is not stored in the storing unit 240. The control unit 230 receives a user input signal with respect to broadcast content provided in the configured EPG screen and collectively manages the broadcast content based on the user input signal in operation S830.

Hereinafter, an EPG providing apparatus and method for providing a video-on-demand (VOD) service using EPG information will be described.

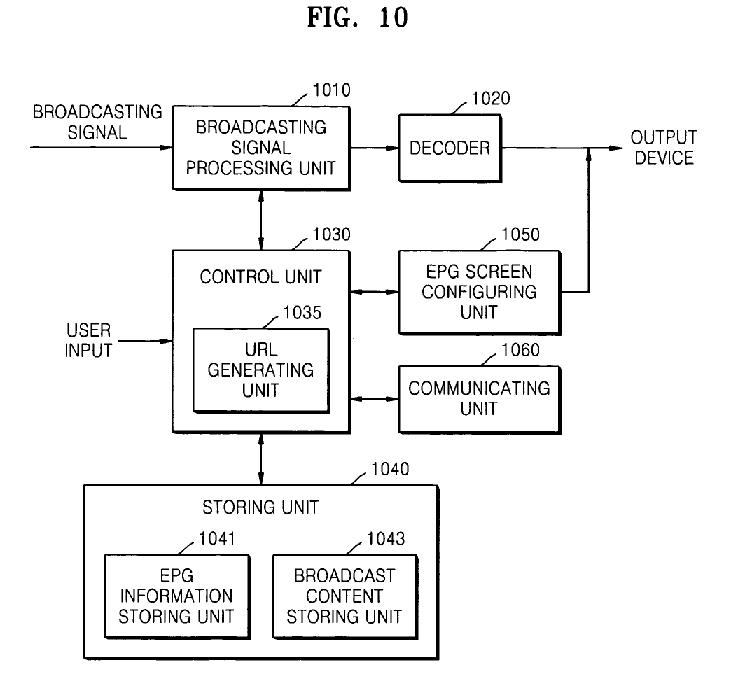

FIG. 9 illustrates a system for providing a VOD service using EPG information according to an exemplary embodiment of the present invention. The system includes a broadcasting station 910, an EPG providing apparatus 920, and a VOD server 930.

The broadcasting station 910 delivers EPG information and broadcast content to the EPG providing apparatus 920 through a broadcasting signal. The EPG information may include titles, broadcasting channels, and broadcasting time of broadcast content, categories of broadcasting programs, the number of broadcasting times, starring actors, and brief information of the broadcast content, etc. Although the EPG providing apparatus 920 illustrated in FIG. 9 is provided with the EPG information from the broadcasting station 910, it may also be provided with the EPG information from an operator or a device that provides an EPG service.

The EPG providing apparatus 920 may be implemented with a personal video recorder (PVR), a personal computer (PC), or other devices capable of receiving and recording broadcast content. The EPG providing apparatus 920 can receive and store EPG information of all broadcasting channels at a specific time set by a user or at the issuance of an EPG information update command. The EPG providing apparatus 920 processes a broadcasting signal and stores the EPG information and broadcast content included in the broadcasting signal in a storing unit 924. A content management application is installed in a control unit 922 to control the EPG information and broadcast content stored in the storing unit 924 and generates a uniform resource locator (URL) using the EPG information. A communicating unit 926 connects to the VOD server 930 using the generated URL in order to be provided with a VOD service. The communicating unit 926 may be provided with broadcast content in a streaming manner.

FIG. 10 is a block diagram of an EPG providing apparatus for providing a VOD service using EPG information according to an exemplary embodiment of the present invention. The EPG providing apparatus includes a broadcasting signal processing unit 1010, a decoder 1020, a control unit 1030, a storing unit 1040, an EPG screen configuring unit 1050, and a communicating unit 1060.

The broadcasting signal processing unit 1010 processes a received broadcasting signal to generate broadcast content and EPG information. The broadcasting signal processing unit 1010 may include a tuner (not shown) that tunes and demodulates a broadcasting signal input through a specific channel selected by the user and outputs a transport stream and a demultiplexer (not shown) that demultiplexes a multiplexed transport stream output from the tuner into EPG information and broadcast content including a video stream and an audio stream. The decoder 1020 receives the video/audio transport streams from the demultiplexer and decodes them to output video/audio signals. The configuration of the broadcasting signal processing unit 1010 may vary with the type of a broadcasting signal to be processed.

The control unit 1030 stores the broadcast content and the EPG information generated by the broadcasting signal processing unit 1010 in the storing unit 1040. The storing unit 1040 may store the broadcast content and the EPG information in different spaces, e.g., an EPG information storing unit 1041 and a broadcast content storing unit 1043 as illustrated in FIG. 10. Upon receipt of a user input signal requesting reserved recording, the control unit 1030 stores reserved recording setting information including reserved recording channel information and reserved recording time information based on the user input signal in the storing unit 1040, controls the broadcasting signal processing unit 1010 to be tuned to a reserved recording channel at the reserved recording time, and stores a received broadcasting program in the storing unit 1040, thereby performing the reserved recording.

Upon receipt of a user input signal requesting an EPG from a user input device such as a remote control device, the control unit 1030 reads the EPG information stored in the storing unit 1040 and controls the EPG screen configuring unit 1050 to configure an EPG screen to provide an EPG to the user using the read EPG information. The EPG screen configuring unit 1050 then processes the stored EPG information into a format that can be displayed on a screen.

The EPG screen configuring unit 1050 may display EPG information for past, current, and future broadcast content under the control of the controller 1030. In a related EPG providing apparatus, EPG information that is previously provided by an EPG provider such as a broadcasting station is deleted without being stored. However, the EPG providing apparatus according to an exemplary embodiment of the present invention stores previously provided EPG information in the storing unit 1040. Thus, when the user requests an EPG, the EPG providing apparatus, according to an exemplary embodiment of the present invention, can provide an EPG including information on not only current and future broadcast content but also on past broadcast content.

Thus, the user may be provided with EPG information for past, current, and future broadcast content on an EPG screen by manipulating a remote control device and can select past broadcast content. The control unit 1030 provides information on broadcast content stored in the broadcast content storing unit 1043 to the EPG screen configuring unit 1050. When the EPG screen configuring unit 1050 displays EPG information for the past broadcast content, it configures the EPG screen such that the EPG screen includes information indicating whether past broadcast content has been recorded and stored in the storing unit 1040. When the EPG screen configuring unit 1050 displays EPG information for the past broadcast content, it may also configure the EPG screen such that the EPG screen includes information indicating past broadcast content that can be provided through a VOD service.

When the EPG screen configuring unit 1050 displays EPG information for the current broadcast content, it may also configure the EPG screen to include information indicating current broadcast content is being recorded. When the EPG screen configuring unit 1050 displays EPG information for the future broadcast content, it may also configure the EPG screen such that the EPG screen includes information indicating the future broadcast content is subject to reserved recording using reserved recording setting information that is set by the user input signal and provided from the control unit 1030.

When the user selects past broadcast content on the EPG screen, the control unit 1030 provides the selected past broadcast content. The control unit 1030 determines whether the broadcast content selected by the user input signal is stored in the storing unit 1040 and provides the broadcast content based on the determination. If the broadcast content selected by the user input signal is stored in the storing unit 1040, the control unit 1030 reads the stored broadcast content from the storing unit 1040 and controls the decoder 1020 to decode and reproduce the read broadcast content. If the selected broadcast content is not stored in the storing unit 1040, the control unit 1030 can provide a VOD service for the selected broadcast content. Even when the selected broadcast content is stored in the storing unit 1040, a VOD service can also be provided in response to a user input signal requesting the VOD service if new information is added to the VOD service.

The control unit 1030 generates a URL using the EPG information stored in the storing unit 1040 to provide a VOD service for broadcast content using the EPG information. The control unit 1030 includes a URL generating unit 1035 for generating a URL using the stored EPG information. The URL generated by the URL generating unit 1035 is delivered to the communicating unit 1060 and the communicating unit 1060 connects to the VOD server 930 for providing the VOD service using the delivered URL.

The URL generating unit 1035 may generate a URL using a previously stored address and port number of the VOD server 930, broadcasting channel number information and broadcasting start time information of the selected broadcast content included in the EPG information. When the VOD server 930 requests member authentication, the URL generating unit 1035 may generate a URL by additionally using a user ID and a user password required for the member authentication. Information about the user ID and user password may be appropriately encrypted.

The communicating unit 1060 then transmits a VOD service request for the selected broadcast content to the VOD server 903 using the URL, provided with the VOD service for the selected broadcast content from the VOD server 903, and provides the VOD service to the user. The communicating unit 1060 may be provided with the VOD service in a streaming manner. The communicating unit 1060 may communicate with a VOD server that provides VOD services without a fee using a communication protocol such as hyper-text transfer protocol (HTTP) or real-time transport protocol (RTP). The communicating unit 1060 may also communicate with a VOD server that provides VOD services with a fee using HTTP or other security communication protocols.

FIG. 11 illustrates a table showing elements of a URL for a VOD service according to an exemplary embodiment of the present invention. The URL according to an exemplary embodiment of the present invention may be configured as follows.

http(s)://operator_server_address: operator_server_port number/vod_service.asp.major=channel major number & minor=channel minor number & starttime=program start time (&userid=user ID & password=password)

As can be seen in the table of FIG. 11, the operator server address means a server address of a VOD operator (Internet Protocol (IP) or Data Source Name (DSN)) and the operator server port number means a server port number of the VOD operator. The operator server address and the operator server port number may be input by the user or previously stored. The channel major number means a major number of a broadcasting channel of broadcast content and the channel minor number means a minor number of the broadcasting channel of the broadcast content. The program start time means the broadcasting start time of the broadcast content. The channel major number, the channel minor number, and the program start time can be obtained from EPG information. The user ID and user password are set when it is registered in a VOD server which requires billing for a VOD service or member authentication.

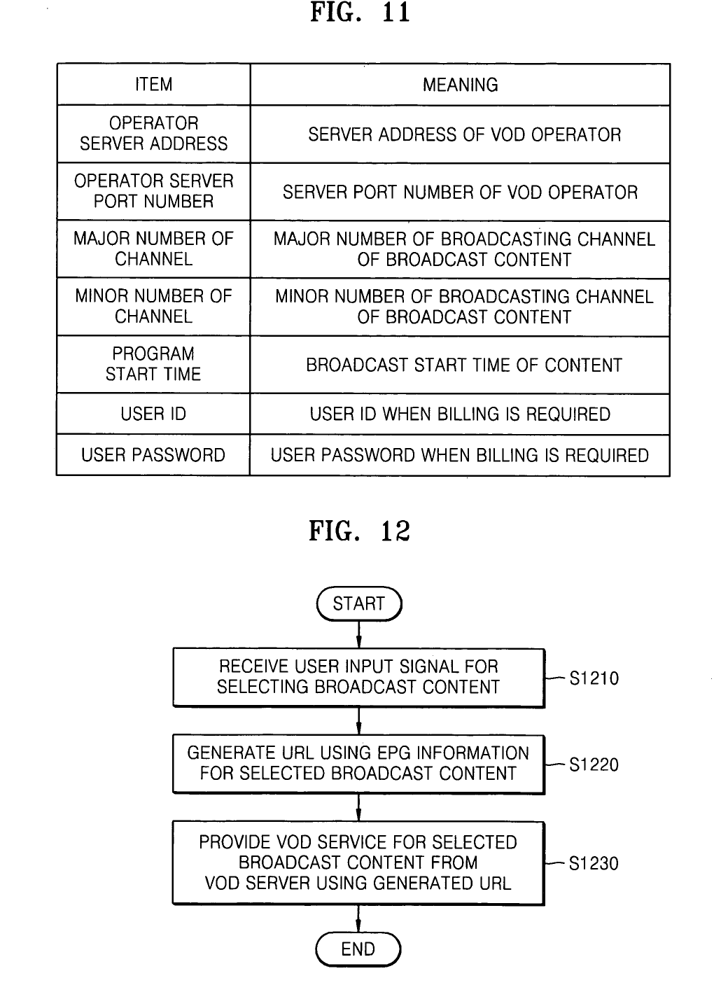

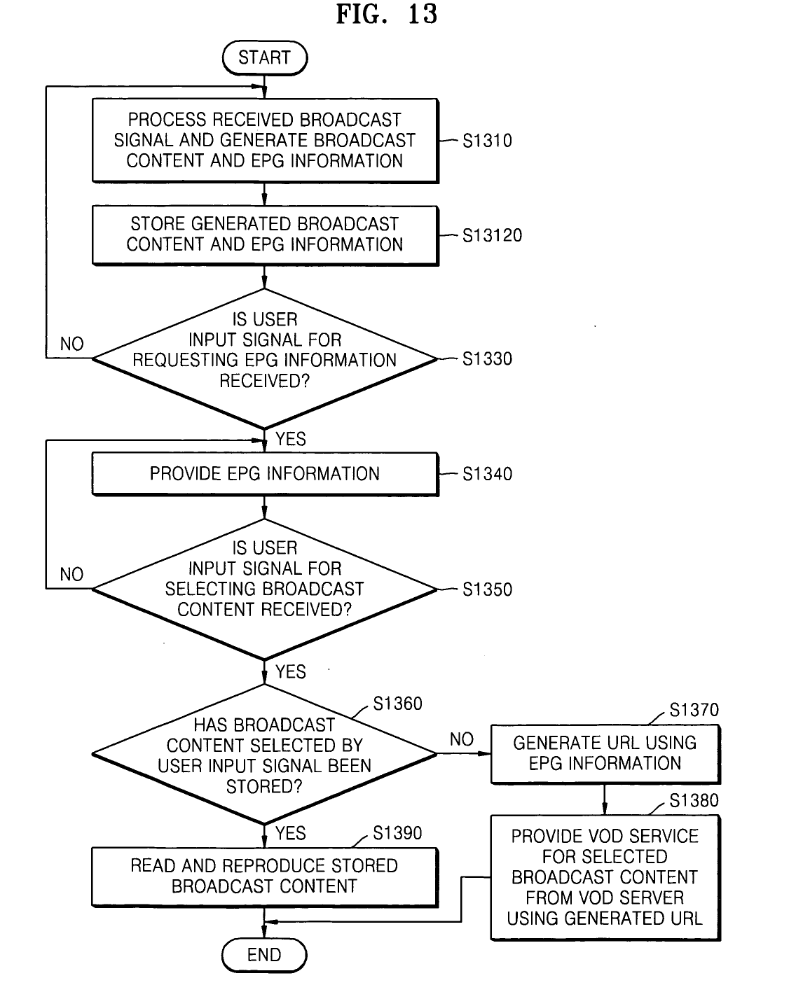

FIG. 12 is a flowchart illustrating a VOD service providing method using EPG information according to an exemplary embodiment of the present invention.

Upon receipt of a user input signal for selecting broadcast content in operation S1210, the control unit 1030 generates a URL using EPG information for the selected broadcast content in operation S1220.

The generated URL is delivered to the communicating unit 1060 and the communicating unit 1060 connects to a VOD server for providing a VOD service using the delivered URL and is provided with the VOD service for the selected broadcast content in operation S1230. The communicating unit 1060 transmits a VOD service request for streaming of the VOD service for the selected broadcast content to the VOD server and is provided with the VOD service in a streaming manner. The control unit 1030 then controls the decoder 1020 to decode the broadcast content streamed through the VOD service and provide the broadcast content to the user.

FIG. 13 is a flowchart illustrating a VOD service providing method using EPG information according to another exemplary embodiment of the present invention.

The broadcasting signal processing unit 1010 processes a received broadcasting signal to generate broadcast content and EPG information in operation S1310. The control unit 1020 stores the broadcast content and the EPG information in the storing unit 1040 in operation S1320. Upon receipt of a user input signal requesting EPG information in operation S1330, the control unit 1030 reads the EPG information stored in the storing unit 1040 and delivers the EPG information to the EPG screen configuring unit 1050.

The EPG screen configuring unit 1050 configures and provides an EPG screen to display EPG information for past, current, and future broadcast content in operation S1340.

If a user input signal for selecting past broadcast content is input in operation S1350, the control unit 1030 searches the storing unit 1040 to determine whether the selected broadcast content is stored in the storing unit 1040 in operation S1360. If the selected broadcast content is not stored in the storing unit 1040, the control unit 1030 generates a URL using EPG information and delivers the generated URL to the communicating unit 1060 in operation S1370.

The communicating unit 1060 transmits a request for a VOD service for the selected broadcast content to the VOD server using the generated URL and is provided with the VOD service for the selected broadcast content from the VOD server in operation S1380. The control unit 1030 then controls the decoder 1020 to decode the broadcast content received through the VOD service and provide the decoded broadcast content to the user. When the selected broadcast content is stored in the storing unit 1040, the control unit 1030 reads the broadcast content stored in the storing unit 1040 and controls the decoder 1020 to decode and reproduce the stored broadcast content in operation S1390.

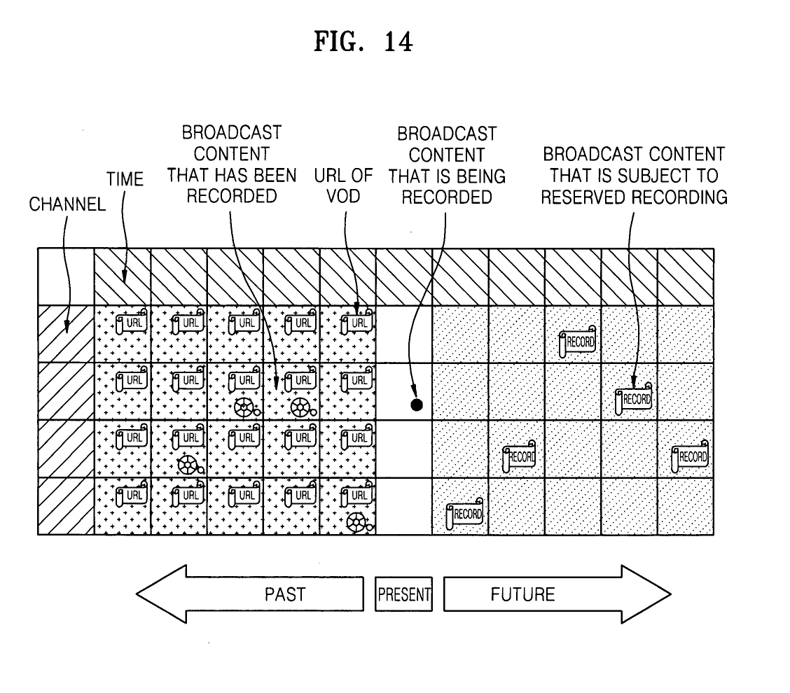

FIG. 14 illustrates a screen for providing a VOD service using EPG information according to an exemplary embodiment of the present invention.

As illustrated in FIG. 14, a screen for providing a VOD service using EPG information has a channel axis and a time axis and displays EPG information for past, current, and future broadcast content. When EPG information for past broadcast content is displayed, information indicating whether the past broadcast content have been recorded can also be displayed. When the EPG information for the past broadcast content is displayed, information indicating the past broadcast content can be provided through a VOD service, i.e., a URL of the VOD service as illustrated in FIG. 11, can also be displayed. When EPG information for current broadcast content is displayed, information indicating that the current broadcast content are being recorded can also be displayed. When EPG information for future broadcast content is displayed, information indicating whether the future broadcast content are subject to reserved recording can also be displayed.

Meanwhile, the present invention can also be embodied as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (e.g., transmission over the Internet). The computer-readable recording medium can also be distributed over network coupled computer systems so that the computer-readable code is stored and executed in a distributed fashion.

As described above, according to the present invention, by storing EPG information for past broadcast content and providing the stored EPG information to a user, the user can use an EPG for the past broadcast content. Thus, information on past broadcast content that has been recorded in an EPG providing apparatus is provided together with EPG information for current or future broadcast content, thereby allowing the user to collectively manage the broadcast content. Furthermore, a screen for providing information on past broadcast content is provided to the user according to a user's requirements, thereby allowing the user to efficiently use the past broadcast content.

Furthermore, EPG information for past broadcast content can be stored and provided and non-recorded broadcast content can be provided by a VOD service. In addition, since an EPG screen is configured using a previously stored EPG information and a URL is generated using the EPG information for a VOD service from a VOD server, the user can be rapidly provided with the EPG information and the VOD service. EPG information for past, current, and future broadcast content is provided in a single screen, thereby facilitating user's management of the broadcast content.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electronic programming guide (EPG) providing apparatus comprising:
a storing unit which stores broadcast content and EPG information;
an EPG screen configuring unit which configures an EPG screen including information on past, current, and future broadcast content; and
a control unit which collectively manages broadcast content provided on the EPG screen based on a user input signal for the broadcast content.

2. The EPG providing apparatus of claim 1, further comprising:
a broadcasting signal processing unit which processes a received broadcasting signal and generates the broadcast content and the EPG information; and
a decoder which decodes the broadcast content that is read from the storing unit or generated by the broadcasting signal processing unit.

3. The EPG providing apparatus of claim 1, wherein the EPG screen configuring unit uses the EPG information such that the broadcast content stored in the storing unit is distinguished from broadcast content that is not stored in the storing unit.

4. The EPG providing apparatus of claim 1, wherein the EPG screen configuring unit omits regions for providing information on broadcast content that are not included in the broadcasting time frames of the stored broadcast content or reduces the sizes of the regions when it configures the EPG screen to provide information on the past broadcast content.

5. The EPG providing apparatus of claim 3, wherein the control unit controls the EPG screen configuring unit to display information on broadcast content included in the reduced region selected by a selection signal upon receipt of the selection signal with respect to the reduced region.

6. The EPG providing apparatus of claim 1, wherein the EPG screen configuring unit reduces the sizes of regions for providing information on broadcast content, which are included in the broadcasting time frames of the stored broadcast content or are not broadcasted through different channels than the stored broadcast content, when it configures the EPG screen to provide information on the past broadcast content.

7. The EPG providing apparatus of claim 1, wherein the control unit controls the decoder to decode and reproduce broadcast content selected by a selection signal with respect to the past broadcast content stored in the storing unit or manages the broadcast content stored in the storing unit by deleting or changing the stored broadcast content.

8. The EPG providing apparatus of claim 1, wherein the EPG screen configuring unit configures the EPG screen such that the EPG screen includes information indicating that the current broadcast content is being recorded, and
the control unit controls the decoder to decode and reproduce current broadcast content selected by a selection signal with respect to the current broadcast content.

9. The EPG providing apparatus of claim 1, wherein the EPG screen configuring unit configures the EPG screen such that the EPG screen includes information indicating whether the future broadcast content are subject to reserved recording, and
the control unit sets or cancels the reserved recording of future broadcast content selected by a selection signal with respect to the future broadcast content.

10. An electronic programming guide (EPG) providing method, comprising:
storing broadcast content and EPG information;
configuring an EPG screen including information on past, current, and future broadcast content using the EPG information; and
collectively managing broadcast content provided on the EPG screen based on a user input signal for the broadcast content.

11. The EPG providing method of claim 10, further comprising:
processing a received broadcasting signal and generating the broadcast content and the EPG information; and
decoding the stored broadcast content or the generated broadcast content.

12. The EPG providing method of claim 10, wherein the stored broadcast content is distinguished from broadcast content that is not stored.

13. The EPG providing method of claim 10, wherein the configuring of the EPG screen comprises omitting regions for providing information on broadcast content that is not included in the broadcasting time frames of the stored broadcast content or reducing the sizes of the regions when configuring the EPG screen to provide information on the past broadcast content.

14. The EPG providing method of claim 13, further comprising displaying information on broadcast content included in the reduced region selected by a selection signal upon receipt of the selection signal with respect to the reduced region.

15. The EPG providing method of claim 10, wherein the configuring of the EPG screen comprises reducing the sizes of regions for providing information on broadcast content, which is not included in the broadcasting time frames of the stored broadcast content or is broadcasted through different channels than the stored broadcast content when configuring the EPG screen to provide information on the past broadcast content.

16. The EPG providing method of claim 10, wherein the managing of the broadcast content comprises decoding and reproducing broadcast content selected by a selection signal with respect to the stored past broadcast content.

17. The EPG providing method of claim 10, wherein the managing of the broadcast content comprises managing the stored broadcast content by deleting or changing the stored broadcast content

18. The EPG providing method of claim 10, wherein the configuring of the EPG screen comprises configuring the EPG screen such that the EPG screen includes information indicating that the current broadcast content is being recorded, and
the managing of the broadcast content comprises decoding and reproducing current broadcast content selected by a selection signal with respect to the current broadcast content.

19. The EPG providing method of claim 10, wherein the configuring of the EPG screen comprises configuring the EPG screen such that the EPG screen includes information indicating whether the future broadcast content is subject to reserved recording, and
the managing of the broadcast content comprises setting or canceling the reserved recording of future broadcast content selected by a selection signal with respect to the future broadcast content.

20. A computer-readable recording medium having recorded thereon a program for implementing an EPG (electronic programming guide) providing method of claim 10.

21. An electronic programming guide (EPG) providing apparatus for providing a video-on-demand (VOD) service using EPG information, the EPG providing apparatus comprising:
a storing unit which stores broadcast content and EPG information;
a control unit which receives a user input signal for selecting broadcast content, reads EPG information for the selected broadcast content from the storing unit, and generates a URL (uniform resource locator) using the read EPG information; and
a communicating unit which receives a VOD service for the selected broadcast content from a VOD server that provides VOD services using the generated URL.

22. The EPG providing apparatus of claim 21, wherein the control unit comprises a URL generating unit which generates the URL using a previously stored address and port number of the VOD server and broadcasting channel number information and broadcasting start time information of the selected broadcast content included in the EPG information.

23. The EPG providing apparatus of claim 22, wherein the URL generating unit generates the URL by additionally using a user ID and a user password required for member authentication if the VOD server requires the member authentication.

24. The EPG providing apparatus of claim 21, further comprising:
a signal processing unit which processes a received broadcasting signal and generates the broadcast content and the EPG information; and
a decoder which decodes and outputs the broadcast content,
wherein the control unit stores the generated broadcast content and EPG information in the storing unit and controls the decoder to decode and provide the broadcast content.

25. The EPG providing apparatus of claim 21, wherein the communication unit receives the VOD service for the selected broadcast content from the VOD server in a streaming manner.

26. The EPG providing apparatus of claim 21, further comprising an EPG screen configuring unit which processes the stored EPG information into a format that can be displayed on a screen,
wherein the EPG screen configuring unit configures an EPG screen to display EPG information for past, current, and future broadcast content.

27. The EPG providing apparatus of claim 26, wherein the EPG screen configuring unit configures the EPG screen such that the EPG screen includes information indicating whether the past broadcast content has been recorded and stored in the storing unit.

28. The EPG providing apparatus of claim 26, wherein the EPG screen configuring unit configures the EPG screen such that the EPG screen includes information indicating that the past broadcast content can be provided through the VOD service.

29. The EPG providing apparatus of claim 26, wherein the EPG screen configuring unit configures the EPG screen such that the EPG screen includes information indicating whether the future broadcast content are subject to reserved recording.

30. The EPG providing apparatus of claim 21, wherein the control unit determines if the broadcast content selected by the user input signal is stored in the storing unit, generates a URL using the read EPG information to provide the VOD service for the selected broadcast content if the selected broadcast content is not stored in the storing unit, and reads and reproduces the selected broadcast content if the selected broadcast content is stored in the storing unit.

31. An electronic programming guide (EPG) providing method comprising:
receiving a user input signal for selecting broadcast content;
generating a uniform resource locator (URL) using EPG information for the selected broadcast content; and
receiving a video-on-demand (VOD) service for the selected broadcast content from a VOD server that provides VOD services using the generated URL.

32. The EPG providing method of claim 31, wherein the generating the URL using the EPG information comprises generating the URL using a previously stored address and a port number of the VOD server and broadcasting channel number information and broadcasting start time information of the selected broadcast content included in the EPG information.

33. The EPG providing method of claim 32, wherein generating the URL using the EPG information comprises generating the URL by additionally providing a user ID and a user password required for member authentication if the VOD server requires the member authentication.

34. The EPG providing method of claim 31, further comprising:
processing a received broadcasting signal and generating the broadcast content and the EPG information;
storing the generated broadcast content and EPG information; and
decoding and outputting the broadcast content,

35. The EPG providing method of claim 31, wherein the VOD service for the selected broadcast content is provided from the VOD server in a streaming manner.

36. The EPG providing method of claim 31, further comprising configuring an EPG screen to display EPG information for past, current, and future broadcast content.

37. The EPG providing method of claim 36, wherein the configuring of the EPG screen comprises configuring the EPG screen such that the EPG screen includes information indicating whether the past broadcast content has been recorded and stored in the storing unit when displaying the EPG information for the past broadcast content.

38. The EPG providing method of claim 36, wherein the configuring of the EPG screen comprises configuring the EPG screen such that the EPG screen includes information indicating that the past broadcast content can be provided through the VOD service when displaying the EPG information for the past broadcast content.

39. The EPG providing method of claim 36, wherein the configuring of the EPG screen comprises configuring the EPG screen such that the EPG screen includes information indicating whether the future broadcast content is subject to reserved recording when displaying the EPG information for the future broadcast content.

40. The EPG providing method of claim 31, further comprising determining whether the broadcast content selected by the user input signal is stored,
wherein a URL is generated using the read EPG information to provide the VOD service for the selected broadcast content if the selected broadcast content is not stored, and the selected broadcast content is read and reproduced if the selected broadcast content is stored.

41. A computer-readable recording medium having recorded thereon a program for implementing an EPG providing method for providing a VOD service using EPG information of claim 31.
